(19) United States
(12) Patent Application Publication
(10) Pub. No.: US 2020/0232928 A1
(43) Pub. Date: Jul. 23, 2020

(54) INDICATOR SYSTEM

(71) Applicant: Covestro Deutschland AG, Leverkusen (DE)

(72) Inventors: Jan WEIKARD, Leverkusen (DE); Lydia KRÖGER, Köln (DE); Mario LORENZ, Lohmar (DE)

(21) Appl. No.: 16/639,168

(22) PCT Filed: Aug. 14, 2018
(86) PCT No.: PCT/EP2018/072047

§ 371 Date: Feb. 14, 2020

(30) Foreign Application Priority Data
Aug. 16, 2017 (EP) 17186372.3

(51) Int. Cl. G01N 21/78; G01N 31/22

(52) U.S. Cl. CPC G01N 21/78; G01N 31/22

(57) ABSTRACT

The invention relates to an indicator system, a method for optically displaying the progress of curing a composition, the use of colourants with a xanthene skeleton to optically display the progress of curing compositions, a kit-of-parts, and a method for increasing the clock rate between a coating step and an additional, downstream processing step for objects.

The invention relates to an indicator system, to a method for optically indicating the curing progress of a composition, to the use of dyes with xanthene skeleton for optically indicating the curing progress of compositions, to a kit of parts, and to a method for increasing the cycle frequency between a coating step and a further downstream step of processing objects.

In coating operations there is a need to progress them as quickly and hence cost-effectively as possible. An advantage here is if there is an easy means of determining whether a coating material already possesses the degree of curing desired for further processing. Especially in the case of nonautomated coating operations, which are subject to a host of variables influencing the curing process, such as ambient temperature, atmospheric humidity, air movement, substrate temperature, and coating material temperature, for example, and in the context, for example, of automotive refinishing, a reliable indication of the degree of curing is important. For example, contact with the not yet fully cured finish on an automobile always harbors the risk of damage to the soft coating film. Curing ought therefore to be indicated contactlessly, by a change in color, for example. In order not to alter the decorative aspect of the finish, the color change ought always to entail the disappearance of the visible coloration—in other words, in the cured coating film, the dye ought to be colorless.

WO 2003/062287 describes adhesives based on acrylates and/or methacrylates, these adhesives curing through influence of UV light and bearing a dye which changes color in the course of curing by radical polymerization induced by UV light. Both xanthene and anthraquinone dyes are disclosed as classes of dye. A disadvantage is that the dye used as indicator is always added to the adhesive, so limiting its use to chemically compatible compositions, and meaning that the possibilities of use are very restricted.

WO 2009/127182 discloses curable compositions prepared from at least one polyol component and at least one isocyanate component, and comprising a color indicator for indicating the progress of curing. Color indicators used are dyes which have a nonaromatic quinoid group. A disadvantage is that the dyes used retain a coloring after the composition has cured, and therefore color said composition, so ruling out their use in colorless curable mixtures, such as clearcoats, for example.

WO 2009/47663 describes a system for skin sealing with a film-forming polymer, the system comprising an indicator dye which changes color when the applied composition undergoes a change in phase. Film-forming polymers referred to are cyanoacrylate adhesives curing by radical polymerization, tosylamide-formaldehyde adhesives, epoxy-based adhesives, and film formers which cure through solvent evaporation but are not described any further. Indicator dyes disclosed are various fluorescein derivatives, which are added to the applied composition. The main disadvantage is that the fluorescein derivatives used also strongly color the cured composition so ruling out their use in clearcoats.

Disadvantages of the indicator dyes disclosed in the prior art, therefore, are that they are not colorless in the cured composition, so ruling out their use in colorless coatings such as clearcoats, for example, or that the dyes used are used only in compositions which cure by radical polymerization. There is therefore no foreseeable possibility for use in compositions which cure by a polyaddition reaction, as in the case of polyurethane-forming compositions, for example, because of the continual risk here that the dye may be consumed by reaction with reactive components and hence that the optical indication of the curing progress may be distorted.

It was an object of the present invention, accordingly, to provide an indicator system which reliably indicates the curing of a composition comprising isocyanate-containing and isocyanate-reactive components, through a visible change in color, without coloring the composition in the cured state.

It has surprisingly been found that the stated object can be achieved through the indicator system of the invention, in which the dye used as indicator may optionally be applied on an inert carrier.

The invention accordingly provides an indicator system comprising a composition which comprises at least one NCO-reactive compound and at least one polyisocyanate, and comprising at least one indicator dye, the at least one indicator dye having at least one xanthene skeleton, for indicating the curing of the composition by change in color of the at least one indicator dye, characterized in that the at least one indicator dye, has a first color after contacting with the uncured composition and in the cured composition is colorless.

In one preferred embodiment of the indicator system of the invention, the at least one indicator dye is contained in the curable composition.

In one preferred embodiment of the indicator system of the invention, the at least one indicator dye is applied on a surface of an inert carrier, the inert carrier optionally being applied with a second surface, which faces away from the first surface, on a second inert carrier, the second carrier preferably being selected from the group consisting of polymer foils, metal foils, paper and/or card, and the inert carrier being colorless and transparent, and the second carrier preferably being white.

In one preferred embodiment of the indicator system of the invention the at least one indicator dye has at least one fluoran skeleton, and preferably is selected from the group of fluorescein derivatives and rhodamine derivatives which are able to form a spirolactone form, and/or combinations thereof.

In one preferred embodiment of the indicator system of the invention, the at least one polyisocyanate in the composition is an aliphatic and/or cycloaliphatic polyisocyanate, the polyisocyanate preferably being selected from the group consisting of derivatives of hexamethylene diisocyanate and/or of pentamethylene diisocyanate.

In one preferred embodiment of the indicator system of the invention, the at least one NCO-reactive compound is selected from the group consisting of polyacrylate polyols and polyester polyols.

Likewise provided by the invention is a method for optically indicating the curing progress of a composition which comprises at least one NCO-reactive compound and at least one polyisocyanate, characterized in that the method comprises the following steps:
(a) providing at least one indicator dye, the indicator dye having at least one xanthene skeleton,
(b) contacting the at least one indicator dye from step (a) with the uncured composition, the indicator dye having a first color, and
(c) curing the composition, the at least one indicator dye indicating the curing of the composition through color switch from the first color to colorless.

In one preferred embodiment of the method of the invention, the at least one indicator dye from step (a) is applied on a surface of an inert carrier.

In one preferred embodiment of the method of the invention, the inert carrier is a polymer foil or a glass fiber web, preferably a polymer foil, more particularly a polyethylene terephthalate or polycarbonate foil.

In one preferred embodiment of the method of the invention, the inert carrier, by a second surface, which faces away from the first surface, is applied on a second inert carrier, the second carrier preferably being selected from the group consisting of polymer foils, metal foils, paper and/or card, and the inert carrier being colorless and transparent, and the second carrier preferably being white.

Likewise provided by the invention is a method for optically ascertaining the curing progress of a composition comprising at least one NCO-reactive compound and at least one polyisocyanate, with at least one indicator dye having a first color after contacting with the uncured composition and in the cured composition being colorless, the indicator dye having at least one xanthene skeleton, characterized in that, after contacting of the at least one indicator dye with the composition, the color of the at least one indicator dye is compared with a color scale in order to ascertain the curing progress.

Likewise provided by the invention is the use of an indicator dye with xanthene skeleton, preferably with fluoran skeleton, for optically indicating the curing progress of compositions comprising at least one NCO-reactive compound and at least one polyisocyanate, characterized in that the at least one indicator dye has a first color after contacting with the uncured composition and in the sufficiently cured composition is colorless.

In one preferred embodiment of the inventive use of the indicator dye, the composition is a polyurethane coating material, preferably a polyurethane clearcoat.

Likewise provided by the invention is a kit of parts comprising at least one indicator dye, the at least one indicator dye having at least one xanthene skeleton, a composition comprising at least one NCO-reactive compound and at least one polyisocyanate, the at least one indicator dye having a first color after contacting with the uncured composition and in the cured composition being colorless and preferably being applied on a surface of an inert carrier, the inert carrier preferably being applied by a second surface, which faces away from the first surface, on a second inert carrier, the second carrier preferably being white.

Likewise provided by the invention is a method for increasing the cycle frequency between a coating step and a further downstream step in the processing of objects which are coated with a composition which comprises at least one NCO-reactive compound and at least one polyisocyanate, characterized in that at least one indicator dye having a first color after contacting with the uncured composition and in the cured composition being colorless is contacted with the composition in order to indicate the curing progress of the coating, the at least one indicator dye having at least one xanthene skeleton.

The word “a/one” in the context of the present invention in connection with countable parameters is to be understood as meaning the number “one” only when this is stated explicitly (for instance by the expression “precisely one”). When reference is made hereinbelow for example to “a polyisocyanate” the word “a” is to be understood as meaning merely the indefinite article and not the number one, and this also therefore encompasses an embodiment in which two or more, for example structurally dissimilar, polyisocyanates are present.

An NCO-reactive compound is understood to mean a compound that can react with polyisocyanates to give polyaddition compounds, especially polyurethanes, under conditions customary in coating technology. Suitable NCO-reactive compounds used may be any compounds known to those skilled in the art that have a mean OH and/or SH functionality of at least 1.5. These may, for example, be low molecular weight diols (e.g. ethane-1,2-diol, propane-1,3- or -1,2-diol, butane-1,4-diol), triols (e.g. glycerol, trimethylolpropane) and tetraols (e.g. pentaerythritol), polythiols, but also polyhydroxyl compounds such as polyether polyols, polyester polyols, polyurethane polyols, polysiloxane polyols, polycarbonate polyols, polybutadiene polyols, polyacrylate polyols and/or polymethacrylate polyols and copolymers thereof, called polyacrylate polyols hereinafter.

In one preferred embodiment, the at least one NCO-reactive compound is a polyhydroxyl compound. Suitable polyhydroxyl compounds preferably have mass-average molecular weights Mw>500 daltons, measured by means of gel permeation chromatography (GPC) according to DIN 55672-1:2016-03 in tetrahydrofuran at 25° C. against a polystyrene standard, more preferably between 800 and 100 000 daltons, especially between 1000 and 50000 daltons. Suitable polyhydroxyl compounds preferably have an OH number of 30 to 400 mg KOH/g, especially between 100 and 300 KOH/g. The hydroxyl number (OH number) indicates how many mg of potassium hydroxide are equivalent to the amount of acetic acid bound by 1 g of substance in the acetylation. For the determination, a sample of the polyhydroxyl compound is heated with acetic anhydride/pyridine, and the acid formed is titrated with potassium hydroxide solution (DIN EN ISO 4629-2:2016). The glass transition temperatures, measured with the aid of DSC measurements according to DIN-EN-ISO 11357-2:2014, of the polyhydroxyl compounds are preferably between −150° C. and 100° C., more preferably between −120° C. and 80° C.

Suitable polyether polyols are obtainable in a manner known per se by alkoxylation of suitable starter molecules under base catalysis or by the use of double metal cyanide compounds (DMC compounds). Examples of suitable starter molecules for the production of polyether polyols are simple low molecular weight polyols, water, organic polyamines having at least two N—H bonds, or any mixtures of such starter molecules.

Preferred starter molecules for the production of polyether polyols by alkoxylation, in particular by the DMC process, are in particular simple polyols such as ethylene glycol, propylene 1,3-glycol and butane-1,4-diol, hexane-1,6-diol, neopentyl glycol, 2-ethylhexane-1,3-diol, glycerol, trimethylolpropane, pentaerythritol, and low-molecular-weight hydroxyl-containing esters of such polyols with dicarboxylic acids of the type specified hereinafter by way of example, or low-molecular-weight ethoxylation or propoxylation products of such simple polyols, or any desired mixtures of such modified or unmodified alcohols. Alkylene oxides suitable for the alkoxylation are in particular ethylene oxide and/or propylene oxide, which may be used in the alkoxylation in any order or also in a mixture.

Suitable polyester polyols are described, for example, in EP-A-0 994 1 17 and EP-A-1 273 640. Polyester polyols can be produced in a known manner by polycondensation of low molecular weight polycarboxylic acid derivatives, for example succinic acid, adipic acid, suberic acid, azelaic acid, sebacic acid, dodecanedioic acid, tetrahydrophthalic anhydride, hexahydrophthalic anhydride, tetrachlorophthalic anhydride, endomethylenetetrahydrophthalic anhydride, glutaric anhydride, maleic acid, maleic anhydride, fumaric acid, dimer fatty acid, trimer fatty acid, phthalic acid, phthalic anhydride, isophthalic acid, terephthalic acid, citric acid or trimellitic acid, with low molecular weight polyols, for example ethylene glycol, diethylene glycol, neopentyl glycol, hexanediol, butanediol, propylene glycol, glycerol, trimethylolpropane, 1,4-hydroxymethylcyclohexane, 2-methylpropano-1,3-diol, butane-1,2,4-triol, triethylene glycol, tetraethylene glycol, polyethylene glycol, dipropylene glycol, polypropylene glycol, dibutylene glycol and polybutylene glycol, or by ring-opening polymerization of cyclic carboxylic esters such as ε-caprolactone. It is moreover also possible to polycondense hydroxycarboxylic acid derivatives, for example lactic acid, cinnamic acid or ω-hydroxycaproic acid to form polyester polyols. However, it is also possible to use polyester polyols of oleochemical origin. Such polyester polyols can be produced, for example, by full ring-opening of epoxidized triglycerides of an at least partly olefinically unsaturated fatty acid-containing fat mixture containing one or more alcohols having 1 to 12 carbon atoms and by subsequent partial transesterification of the triglyceride derivatives to alkyl ester polyols having 1 to 12 carbon atoms in the alkyl radical.

Suitable polyurethane polyols are preferably produced by reaction of polyester polyol prepolymers with suitable di- or polyisocyanates and are described, for example, in EP-A-1 273 640.

Suitable polysiloxane polyols are described, for example, in WO 2001/009260, and the polysiloxane polyols cited therein can preferably be used in combination with further polyhydroxyl compounds, especially those having higher glass transition temperatures.

In one preferred embodiment, the at least one NCO-reactive compound is a polyacrylate polyol. Suitable polyacrylate polyols are generally copolymers and preferably have mass-average molecular weights Mw of between 1000 and 20 000 daltons, especially between 5000 and 10 000 daltons, measured in each case by means of gel permeation chromatography (GPC) according to DIN 55672-1:2016-03 in tetrahydrofuran at 25° C. against a polystyrene standard. The glass transition temperature of the copolymers is preferably between −100° C. and 100° C., especially between −50° C. and 80° C. (measured by means of DSC measurements according to DIN EN ISO 11357-2:2014). Suitable polyacrylate polyols preferably have an OH number of 60 to 250 mg KOH/g, especially between 70 and 200 mg KOH/g, and an acid number of between 0 and 30 mg KOH/g. The acid number here indicates the number of mg of potassium hydroxide which is used for neutralization of 1 g of the respective compound (DIN EN ISO 2114:2000).

The production of suitable polyacrylate polyols is known to those skilled in the art. They are obtained by radical polymerization of olefinically unsaturated monomers having hydroxyl groups or by radical copolymerization of olefinically unsaturated monomers having hydroxyl groups with optionally other olefinically unsaturated monomers, for example ethyl acrylate, ethyl methacrylate, propyl acrylate, propyl methacrylate, isopropyl acrylate, isopropyl methacrylate, butyl acrylate, butyl methacrylate, isobutyl acrylate, isobutyl methacrylate, tert-butyl acrylate, tert-butyl methacrylate, amyl acrylate, amyl methacrylate, hexyl acrylate, hexyl methacrylate, ethylhexyl acrylate, ethylhexyl methacrylate, 3,3,5-trimethylhexyl acrylate, 3,3,5-trimethylhexyl methacrylate, stearyl acrylate, stearyl methacrylate, lauryl acrylate or lauryl methacrylate, cycloalkyl acrylates and/or cycloalkyl methacrylates, such as cyclopentyl acrylate, cyclopentyl methacrylate, isobornyl acrylate, isobornyl methacrylate or especially cyclohexyl acrylate and/or cyclohexyl methacrylate.

Suitable olefinically unsaturated monomers having hydroxyl groups are especially 2-hydroxyethyl acrylate, 2-hydroxyethyl methacrylate, 2-hydroxypropyl acrylate, 2-hydroxypropyl methacrylate, 3-hydroxypropyl acrylate, 3-hydroxypropyl methacrylate, 3-hydroxybutyl acrylate, 3-hydroxybutyl methacrylate and especially 4-hydroxybutyl acrylate and/or 4-hydroxybutyl methacrylate.

Further monomer units used for the polyacrylate polyols may be vinylaromatic hydrocarbons, such as vinyltoluene, alpha-methylstyrene or especially styrene, amides or nitriles of acrylic acid or methacrylic acid, vinyl esters or vinyl ethers, and in minor amounts especially acrylic acid and/or methacrylic acid.

In a further embodiment, the at least one NCO-reactive compound takes the form of aqueous dispersion. Examples are the abovementioned polyester and/or polyacrylate polyols which have been rendered dispersible with water through incorporation of emulsifying groups and/or through use of emulsifiers. With regard to the polyacrylate polyols, suitability is possessed both by emulsion polymers, where the polymerization takes place in micelles in aqueous phase, and secondary dispersions, for which a polymer is first prepared in bulk or in a little organic solvent and is then dispersed in water. Aqueous polyurethane polyol dispersions are likewise suitable.

Likewise suitable are hydroxyl-terminated polycarbonates obtainable by reaction of diols or else lactone-modified diols or else bisphenols, for example bisphenol A, with phosgene or carbonic diesters such as diphenyl carbonate or dimethyl carbonate. Examples include the polymeric carbonates of hexane-1,6-diol, pentane-1,5-diol and/or butane-1,4-diol with an average molecular weight of ≥500 g/mol to ≤8000 g/mol, and also the carbonates of reaction products of hexane-1,6-diol with ε-caprolactone in a molar ratio of ≥0.1 to ≤1. Preference is given to aforementioned polycarbonate diols with an average molecular weight of ≥800 g/mol to ≤3000 g/mol, based on hexane-1,6-diol, and/or to carbonates of reaction products of hexane-1,6-diol with ε-caprolactone in a molar ratio of ≥0.33 to ≤1. Hydroxyl-terminated polycarbonates are available for example under the Desmophen® C designation from Covestro AG, DE, or under the Eternacoll® designation from Ube Industries, Ltd., JP.

Additionally suitable are hydroxy-terminated polybutadiene polymers of the kind sold for example by Cray Valley, FR under the Poly-bd® designation.

The at least one NCO-reactive compound is preferably selected from the group consisting of polyacrylate polyols and polyester polyols, more particularly polyacrylate polyols.

Suitable polyisocyanates are any polyisocyanates known to those skilled in the art to be suitable for the production of polyisocyanate polyaddition products, especially polyurethanes, especially the group of the organic aliphatic, cycloaliphatic, araliphatic and/or aromatic polyisocyanates having at least two isocyanate groups per molecule, and mixtures thereof. Examples of polyisocyanates of this kind are di- or triisocyanates, for example butane 1,4-diisocyanate, pentane 1,5-diisocyanate (pentamethylene diisocyanate, PDI), hexane 1,6-diisocyanate (hexamethylene diisocyanate, HDI), 4-isocyanatomethyloctane 1,8-diisocyanate (triisocyanatononane, TIN), 4,4′-methylenebis(cyclohexyl isocyanate) (H12MDI), 3,5,5-trimethyl-1-isocyanato-3-isocyanatomethylcyclohexane (isophorone diisocyanate, IPDI), 1,3- and 1,4-bis(isocyanatomethyl)cyclohexane (H6XDI), naphthalene 1,5-diisocyanate, diisocyanatodiphenylmethane (2,2′-, 2,4′- and 4,4′-MDI or mixtures thereof), diisocyanatomethylbenzene (tolylene 2,4- and 2,6-diisocyanate, TDI) and technical grade mixtures of the two isomers, and also 1,3- and/or 1,4-bis(isocyanatomethyl)benzene (XDI), 3,3′-dimethyl-4,4′-biphenyl diisocyanate (TODI), paraphenylene 1,4-diisocyanate (PPDI), tetramethylxylylene 1,3-diisocyanates (TMXDI) and cyclohexyl diisocyanate (CHDI) and the oligomers of higher molecular weight that are obtainable individually or in a mixture from the above and have biuret, uretdione, isocyanurate, iminooxadiazinedione, allophanate, urethane and carbodiimide/uretonimine structural units. Preference is given to the use of polyisocyanates based on aliphatic and cycloaliphatic diisocyanates.

In one preferred embodiment, the at least one polyisocyanate is an aliphatic and/or cycloaliphatic polyisocyanate. In another preferred embodiment, the at least one polyisocyanate is a derivative of hexamethylene diisocyanate and/or of pentamethylene diisocyanate, especially a hexamethylene diisocyanate trimer and/or a pentamethylene diisocyanate trimer. In another preferred embodiment, the at least one polyisocyanate may contain one or more hydrophilizing groups such as, for example, polyethylene oxide units or neutralized sulfonate groups.

The ratio of polyisocyanates to NCO-reactive compounds, based on the amounts of substance of the polyisocyanate groups relative to the NCO-reactive groups, is preferably 0.5:1.0 to 3.0:1.0. Particular preference is given to a ratio of 0.9:1.0 to 1.5:1.0 Very particular preference is given to a ratio of 1.05:1.0 to 1.25:1.0.

In one preferred embodiment, the composition of the indicator system of the invention comprises at least one NCO-reactive compound selected from the group consisting of polyacrylate polyols and polyester polyols and at least one polyisocyanate, the polyisocyanate being a derivate of hexamethylene diisocyanate and/or of pentamethylene diisocyanate. In another preferred embodiment, the composition comprises polyacrylate polyol as NCO-reactive compound, and as polyisocyanate a derivative of hexamethylene diisocyanate and/or of pentamethylene diisocyanate. In another preferred embodiment, the composition comprises polyacrylate polyol as NCO-reactive compound, and as polyisocyanate a hexamethylene diisocyanate trimer and/or a pentamethylene diisocyanate trimer. The composition is preferably not a foamable or foam-forming composition. The composition is preferably not radically polymerizable, especially not photopolymerizable; that is, the composition does not cure through radical processes, especially not through radical polymerization processes which are initiated by actinic radiation. The composition may for example be a coating material or a coating. The composition is preferably a two-component composition (2K composition), meaning that the components are first prepared and stored separately and are not mixed with one another until shortly before or during application. After mixing, the components begin to react with one another. The working time at room temperature, also referred to as pot life, is then situated in the range from 1 minute up to 24 hours, depending on the components selected, and usually in the range from 10 minutes to 8 hours.

Additionally, the composition may comprise adjuvants typical for coating technology with polyisocyanate polyaddition compounds, especially for polyurethane compounds. Examples are catalysts/activators such as, for example, titanium, zirconium, bismuth, tin and/or iron-containing catalysts, as described in WO 2005/058996, for example. It is also possible to add amines or amidines.

Examples of further suitable adjuvants are, in particular, light stabilizers such as UV absorbers and sterically hindered amines (HALS), and also stabilizers, fillers and antisettling agents, defoaming, anticratering and/or wetting agents, leveling agents, film-forming auxiliaries, reactive diluents, solvents, substances for rheology control, slip additives and/or components which prevent soiling and/or improve the cleanability of the cured coatings, and also flatting agents. The use of light stabilizers, especially of UV absorbers, for example substituted benzotriazoles, S-phenyltriazines or oxalanilides, and of sterically hindered amines, especially having 2,2,6,6-tetramethylpiperidyl structures—referred to as HALS—is described by way of example in A. Valet, Lichtschutzmittel für Lacke, Vincentz Verlag, Hanover, 1996.

Stabilizers such as, for example, free-radical scavengers and other polymerization inhibitors such as sterically hindered phenols, stabilize paint components during storage and are intended to prevent discoloration during curing. Additionally contemplated are water scavengers such as triethyl orthoformate or hydrolysis inhibitors such as carbodiimides.

The composition may further comprise pigments, dyes and/or fillers. The pigments used for this purpose including metallic or other effect pigments, dyes and/or fillers are known to those skilled in the art.

Preferred fillers are those compounds that have no adverse effect on the appearance of the coating. Examples are nanoparticles based on silicon dioxide, aluminum oxide or zirconium oxide; reference is also made additionally to the Römpp Lexicon “Lacke und Druckfarben” [Coatings and Printing Inks] Georg Thieme Verlag, Stuttgart, 1998, pages 250 to 252.

If there are fillers, flatting agents or pigments present, the addition of antisettling agents may be advisable to prevent separation of the constituents in the course of storage.

Wetting and leveling agents improve surface wetting and/or the leveling of coatings. Examples are fluoro surfactants, silicone surfactants and specific polyacrylates. Rheology control additives are important in order to control the properties of the two-component system on application and in the leveling phase on the substrate and are known, for example, from patent specifications WO 1994/022968, EP-A-0 276 501, EP-A-0 249 201 or WO 1997/012945; crosslinked polymeric microparticles are disclosed, for example, in EP-A-0 008 127; inorganic sheet silicates such as aluminum-magnesium silicates, sodium-magnesium and sodium-magnesium-fluorine-lithium sheet silicates of the montmorillonite type; silicas such as Aerosil®; or synthetic polymers having ionic and/or associative groups such as polyvinyl alcohol, poly(meth)acrylamide, poly(meth)acrylic acid, polyvinylpyrrolidone, styrene-maleic anhydride or ethylene-maleic anhydride copolymers and derivatives thereof, or hydrophobically modified ethoxylated urethanes, ureas or polyacrylates.

The composition may further comprise solvents. The solvent may be an organic solvent or a mixture of organic solvents, or water or a mixture of organic solvent(s) and water. Suitable solvents should be used after matching to the composition and to the application process, in a manner known to those skilled in the art. Solvents are intended to dissolve the components used and promote the mixing thereof, and to avoid incompatibilities. In addition, during the application and the curing, they should leave the coating in a manner matched to the proceeding crosslinking reaction so as to afford a solvent-free coating with the best possible appearance and without defects such as popping or pinholes. Contemplated solvents include in particular those used in two-component technology. Examples of organic solvents are ketones such as acetone, methyl ethyl ketone or hexanone, esters such as ethyl acetate, butyl acetate, methoxypropyl acetate, substituted glycols and other ethers, aromatics such as xylene or solvent naphtha, for example from Exxon-Chemie, and mixtures of the solvents mentioned. Where the NCO-reactive part of the composition takes the form of an aqueous dispersion, water is also suitable as solvent or diluent.

The composition is produced by methods known per se in the technology of coating materials and printing inks. Isocyanate-reactive and isocyanate-containing components are first prepared separately by mixing the respective ingredients. Mixing only takes place immediately before or during application. Where mixing takes place before application, it should be borne in mind that the reaction of the constituents commences straight after mixing. The reaction will proceed at different rates depending on the selection of the components and of the adjuvants, so resulting in a pot life within which the composition must be applied. The components are selected and the pot life determined in accordance with methods known to those skilled in the art.

Examples of corresponding compositions are commercially available 2K PU coating materials, also known as DD coating materials. These coating materials are sold for applications in particular as surfacers, clearcoats or topcoats, as for example for automotive refinish, large-vehicle finishing, the coating of plastics, automotive finishing, general industrial coating, furniture coating, the coating of floors, or for coating in the building industry. Automotive refinish clearcoats are available, for example, under the name Permasolid® clearcoat and curing agent from Spies-Hecker GmbH, Cologne; and also under the name Glasurit® clearcoat and curing agent from BASF Coatings GmbH, Münster, and additionally under the names Deltron® and Nexa Autocolor® clearcoat and curing agent from PPG Deutschland Sales & Services GmbH, Hilden; and also under the names Sikkens Autoclea® D from Akzo Nobel N.V., Amsterdam.

It is clear to those skilled in the art that the only compositions suitable for the indicator system of the invention are those which do not give rise to color interference with the color change of the indicator dye on curing. These are, in particular, clearcoat materials and also weakly colored or staining coatings, and also light-colored topcoats, especially white topcoats. Particularly preferred are unpigmented clearcoat materials. These compositions and coatings preferably have a pKₐ value without the indicator dye which lies below the pKₐ value of the indicator dye. Interfering in this context means that the change in the color of the indicator dye is no longer visible to the human eye as a result of other pigments, dyes or fillers.

The term “indicator dye” refers in the sense of the present invention to a dye which on contact with the uncured composition of the indicator system of the invention exhibits a first color, and in the cured composition is colorless. In the present context, the term “color” or “hue” refers to that which is perceived by the human eye after absorption of one or more sub-regions within the range of the electromagnet spectrum that is visible to the human eye, from 380 to 780 nm. The hue may for example be red, yellow, green, and blue, or else a variation thereof with respect to chroma and lightness. The transition from the first color to colorless, i.e., the change in color, may be gradual or sudden. The change in color is preferably gradual, meaning that the chroma and/or lightness of the hue of the dye decrease until the dye is colorless. In the case of a sudden change in color (color switch) the decrease in the chroma and/or lightness of the dye is so rapid that it is no longer perceived with the human eye. In the present context, colorless means that no electromagnet radiation in the range of from 380 to 780 nm is absorbed. The human eye is unable to distinguish between the hue of the cured composition without indicator dye and that of the cured composition with indicator dye. More particularly this means that the difference deltaE, colorimetrically according to CIE-L*a*b system (DIN EN ISO 11664-4:2011), is less than 2.5, preferably less than 1.0.

If more than one indicator dye is used, the first color which occurs on contact with the composition is the color which forms as a result of the mixing of the colors of the individual indicator dyes used, after contact with the composition. In one variant, the different indicator dyes may become colorless at different degrees of curing; in other words, in a mixture of two indicator dyes, for example, the first indicator dye becomes colorless as soon as the composition has reached a first degree of curing, and the second dye becomes colorless only as soon as the composition has reached a second degree of curing. This is of interest in particular for applications where different degrees of curing of the composition allow different subsequent steps of work. For example, a first degree of curing may be reached when it is possible to coat the composition with a further composition, and a second degree of curing when it is possible to sand the composition. To those skilled in the art it is clear that in the fully cured composition, all the indicator dyes in the sense of the invention are colorless.

Depending on the indicator dye used, it is possible for different degrees of drying of the coating to be ascertained selectively. The degree of drying indicates the degree of curing of the composition according to DIN EN ISO 9117-5:2012. In accordance with the invention, the term “cured” means that in general at least 50% of the NCO groups, preferably 60%, more preferably 80%, have been consumed by reaction. The term “cured composition” means more particularly that the composition has attained a strength which is sufficient for its further processing. Examples of further processing are sanding, polishing, packing, mounting, laminating, printing, lasering, joining, coating, washing, cleaning, diecutting, stitching, winding, stacking, deforming, testing, subjecting to electric current, removing from a protected environment, or recoating; preferably, further processing is sanding, polishing and/or mounting.

Depending on the input substances used, it may occasionally be the case that the color change of the indicator dye does not take place in the clear way desired, instead, for example, being sluggish or incomplete. In such an event, it is generally enough to add a small amount of acid in order to diminish the basic nature of the curable composition. In such an event, the basic nature of the composition must be lowered to such an extent that the desired color change is restored. The pKₐ of the curable composition without indicator dye is preferably below the pKₐ of the indicator dye. This means that the composition without indicator dye has a higher acid strength than the indicator dye. Acid strengths can be measured relative to a standard, in water or dimethyl sulfoxide, at room temperature (F. G. Bordwell, Acc. Chem. Res. 1988, 21, 456-463).

A suitable indicator dye has at least one xanthene skeleton, preferably a fluoran skeleton. The indicator dye is preferably a fluorescein or rhodamine derivative. Particularly suitable in this context are those derivatives of xanthene and of fluoran that are able to form a spirolactone form. These are, in particular, those derivatives of xanthene and of fluoran which, on the central ring of the xanthene or fluoran skeleton, respectively, on the unannulated carbon (C9 carbon atom of the xanthene or fluoran skeleton), carry a substituent which contains a carboxylic acid group, allowing the carboxylic acid group to form a spirolactone, preferably in the form of a five-membered ring, with the unannulated carbon atom of the xanthene skeleton. The substituent on the unannulated carbon atom is preferably a 2-benzoyl radical or a 2-phenylacetyl radical. Examples include fluorescein and its derivatives and salts, and also rhodamine and its derivatives and salts, especially dibromofluorescein, diiodofluorescein, fluorescein-5-thioisocyanate, fluorescein diacetate, 4- and/or 5-aminofluorescein, 4,5,6,7-tetrachlorofluorescein, 2′,4′,5′,7′-tetrabromofluorescein (eosin Y), 2′,4′,5′,7′-tetraiodofluorescein (erythrosine B), 2′,4′,5′,7′-tetrabromo-3,4,5,6-tetrachlorofluorescein, 2′,4′,5′,7-tetrabromo-3,4,5,6-tetrachlorofluorescein disodium salt (phloxin B), 3,4,5,6-tetrachloro-2′,4′,5′,7′-tetraiodofluorescein (Rose bengal), 3′,4′,5′,6′-tetrahydroxyspiro[2-benzofuran-3,9′-xanthen]-1-one (pyrogallolphthalein), 9-(2-carboxyphenyl)-3,6-bis(diethylamino)xanthylium chloride (rhodamine B), 5-carboxytetramethylrhodamine, and sulfodi-o-tolyldiamino-o-carboxyphenylxanthenene sodium salt (violamine R). Additionally suitable are the fluorescein derivatives described by Xian-Fu Zhang, Jianlong Zhang and Limin Liu in J. Fluoresc. (2014) 24:819-826. Additionally suitable are dyes which are employed in molecular biology as fluorescence probes and/or in fluorophore labeling and contain a xanthene skeleton and are able to form spirolactone form. Examples are compounds sold under the name Alexa Fluor® by Molecular Probes, Inc., Eugene, USA. Alexa Fluor® 488, 546 and 568 are suitable in particular. For all of the aforesaid dyes it is possible to employ—insofar as chemically preparable—not only the pure acids or bases but also salts thereof, such as sodium salts of the fluorescein derivatives or chlorides of the rhodamine derivatives, for example. Preferred dyes are those whose change in color on curing of the composition is readily visible with respect to the background and to any existing coloration of the composition. An example of such a change in color is the partial or preferably complete decoloring of a red dye, which on many substrates has better visibility for the eye than the decoloring of a yellow dye.

The at least one indicator dye is preferably selected from the group consisting of fluorescein derivatives and/or rhodamine derivatives and/or combinations thereof, especially those which are able to form a spirolactone form, i.e. having on the central ring of the xanthene skeleton, on the unannulated carbon (C9 carbon atom of the xanthene skeleton), a substituent which comprises a carboxylic acid group, this carboxylic acid being able to form a spirolactone with said unannulated carbon atom. Particularly preferred are fluorescein derivatives which are able preferably to form a spirolactone form. Particularly preferred are 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof. Especially preferred is 3,4,5,6-tetrachloro-2′,4′,5′,7′-tetrabromofluorescein and also its disodium salt (phloxine B).

The at least one indicator dye may additionally be mixed with auxiliaries and adjuvants such as solvents, stabilizers, fillers and also antisettling agents, defoaming, anticrater and/or wetting agents, dispersing assistants, leveling agents, film-forming assistants, and substances for rheology control.

Suitable solvents should be used in a form matched to the indicator dye and also to the composition and the application method, as is known to those skilled in the art. Solvents are intended to dissolve the indicator dye or dyes and to promote the mixing thereof—optionally also with the composition—and also to avoid incompatibilities. The indicator dyes are usually highly soluble in water and/or alcohols, and so these solvents are preferred.

In one preferred embodiment, the at least one indicator dye of the indicator system of the invention is mixed with auxiliaries and adjuvants according to customary techniques. It is preferred here for the at least one indicator dye to be present in dissolved form, or to be deposited from dissolved form such as to allow it to be brought back into solution as rapidly as possible and as completely as possible by the other constituents of the composition of the indicator system of the invention. In one preferred embodiment, the at least one indicator dye is mixed with at least one dispersing assistant which supports the redissolution of the deposited indicator dye.

In one embodiment of the present invention, the at least one indicator dye is contained in the curable composition in a manner of a homogeneous substance mixture. For this purpose, the at least one indicator dye is mixed with the composition of the indicator system of the invention, preferably first with mixing with the NCO-reactive constituents and no addition of the NCO-containing constituents until immediately prior to application. Mixing in this case takes place by techniques customary in the coating technology of two-component polyurethane paints (2K PU paints), as for example by mixing, by stirring or by conveying the two components through a mixing assembly such as a static mixer, for example. As a result of the addition of the at least one indicator dye, the skilled person is also able to visualize the mixing of the constituents of the composition. The homogeneity of the mixture is evident from the disappearance of any visible streaks of color and from the attainment of a uniform hue, i.e. a first color. The color change or change in color of the at least one indicator dye, which indicates the progress of curing, starts after the at least one NCO-reactive compound has been combined with the at least one polyisocyanate component, and after application, during the curing of the composition, and the first color or hue fades increasingly as the curing of the composition increases, until eventually the at least one indicator dye is colorless and the composition is cured. The degree of color change in this case correlates preferably with the degree of curing.

In one preferred embodiment, the composition, more preferably the at least one NCO-reactive compound or component, is admixed with the at least one indicator dye in a concentration of 0.001 to 1.0%, preferably 0.01 to 0.1%, based on the mass of the composition that is nonvolatile during application and drying and curing. The amount of indicator dye added here is dependent on the dye itself, on the film thickness of the cured composition, and on the constitution of the composition or NCO component. At concentrations below 0.001%, however, the color intensity is generally no longer sufficient for a color change to still be recognized. Concentrations above 1.0%, on the other hand, are unnecessary for unambiguous recognition of the color change. In each case the required concentration, relative to dye, composition and applied film thickness, can be ascertained easily and reliably in simple preliminary tests, by varying the dye concentration.

In one preferred embodiment, the indicator system of the invention comprises a composition which comprises at least one NCO-reactive compound selected from the group consisting of polyacrylate polyols and polyester polyols and at least one polyisocyanate, the polyisocyanate being a derivative of hexamethylene diisocyanate and/or of pentamethylene diisocyanate, and comprises at least one indicator dye selected from the group of fluorescein and rhodamine derivatives which are able to form a spirolactone form. In a further preferred embodiment, the indicator system of the invention comprises a composition comprising at least one NCO-reactive compound, the NCO-reactive compound being a polyacrylate polyol, and at least one polyisocyanate, the polyisocyanate being a derivative of hexamethylene diisocyanate and/or the pentamethylene diisocyanate and at least one indicator dye, the at least one indicator dye being a fluorescein derivative which is able to form a spirolactone form. In a further preferred embodiment, the indicator system of the invention comprises a composition comprising at least one NCO-reactive compound, the NCO-reactive compound being a polyacrylate polyol, and at least one polyisocyanate, the polyisocyanate being a derivative of hexamethylene diisocyanate and/or the pentamethylene diisocyanate, and at least one indicator dye selected from the group consisting of 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof.

The composition comprising the at least one indicator dye is applied to a substrate by means of suitable techniques. Examples of application techniques are printing, spreading, roller coating, pouring, knifecoating, rolling, dipping, fluidized-bed processes and/or, preferably, spraying, such as compressed air spraying, airless spraying and high-speed rotary atomization, for example. Spray application may optionally be combined with electrostatic charging of the atomized particles (ESTA), and/or may optionally be combined with hot spray application such as hot-air hot spraying or hot steam spraying, for example. In the case of spraying techniques which utilize a gas for atomizing and/or for transferring the atomized particles, suitable gases include not only air but also other gases such as nitrogen, carbon dioxide or water vapor, for example.

In one alternative embodiment of the invention, the at least one indicator dye is applied on the surface of an inert carrier. For this purpose, the at least one indicator dye is first applied to a carrier material. The carrier material comprising the at least one indicator dye is coated with the composition jointly with the substrate in a temporally and/or spatially separate step, so that the at least one indicator dye comes into contact only with the coating on the carrier material, and not with the coating on the substrate. On contacting with the composition, the at least one indicator dye is parted from the carrier and mixes with the composition on the carrier material. The curing of the coating on the substrate is then reliably indicated by the change in color of the composition on the carrier material. Employing this alternative embodiment is advisable in the case of substrates or objects which already have a coating or inherent color that is the same as or resembles the hue of the at least one indicator dye, so that the change in color is difficult or impossible to see.

The amount of indicator dye relative to the composition ought to be selected so that it is at least high enough to allow the decoloring to be monitored readily with the eye in the course of curing. On the other hand, it ought not to be so high that the addition of the indicator dye influences the curing, in the manner of a filler, for example. Generally speaking, indicator dye concentrations of between 5 and 5000 mg/kg are suitable, preferably between 50 and 1000 mg/kg, more particularly between 100 and 500 mg/kg, based on the pure indicator dye and on the nonvolatile constituents of the composition. The nonvolatile constituents can be determined according to DIN EN ISO 3251:2008 on a sample of 2.0 g in a forced air oven at 100° C. with a residence time of 120 minutes.

Suitable carriers and carrier materials are those on which the at least one indicator dye can be applied in such a way that on coating with the composition, it parts from the carrier material again, is dissolved in the applied composition, and so indicates the curing of the coating or composition through a change in color. Suitable carrier materials are, for example, foils of plastic or metal, papers, cardboard, multilayer laminates of the aforesaid materials, and also of aforesaid materials coated with a fiberlike layer of—for example—cellulose, cotton, textile and/or glass fibers. Additionally, aforesaid materials provided with a coating film or adhesive layer to which the indicator dye is applied. Preferred carrier materials here are those with surfaces from which the at least one indicator dye goes back most easily into the composition after the coating of the carrier material with the composition. Examples of these are polymeric foils, especially those of polyvinyl acetate, polyesters, polycarbonate or polymethyl methacrylate, more particularly of polycarbonate or polyethylene terephthalate. The foils may be smooth or may have rough, textured surfaces. The carrier material is preferably white at least on the surface to which the at least one indicator dye is applied, when the composition is a clearcoat, since changes in color can be discerned with particular ease by the human eye against a white background. If the composition is not a clearcoat, but is instead pigmented, then the carrier material is preferably transparent and uncolored, allowing a change in color to be observed with the eye through the carrier material. The inert carrier is preferably a polymer foil or a glass fiber web, more preferably a polymer foil, more particularly a polyethylene terephthalate foil or polycarbonate foil. In one preferred embodiment, the inert carrier is colorless and transparent.

In a further embodiment, the at least one indicator dye is applied on a first surface of an inert carrier, the inert carrier, by a second surface, which faces away from the first surface, being applied on a second inert carrier. Carriers contemplated for the second inert carrier are all those stated above. The second carrier is preferably selected from the group consisting of polymer foils, metal foils, paper and/or card. In one preferred embodiment, the first carrier is colorless and transparent, and the second carrier is white. This has the advantage of better visibility of the evolution in color by the indicator dye on curing of the composition.

In one preferred embodiment, the inert carrier is a polymer foil or a glass fiber web and the at least one indicator dye is a fluorescein and/or rhodamine derivative which is able to form a spirolactone form, more particularly a fluorescein derivative which is able to form a spirolactone form. In another preferred embodiment, the inert carrier is a polymer foil and the at least one indicator dye is selected from the group consisting of 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof. In one preferred embodiment, the inert carrier is a polymer foil or a glass fiber web, the second inert carrier is selected from the group consisting of polymer foils, metal foils, paper and/or card, and the at least one indicator dye is a fluorescein and/or rhodamine derivative which is able to form a spirolactone form, more particularly a fluorescein derivative which is able to form a spirolactone form. In another preferred embodiment, the inert carrier is a polymer foil, the second inert carrier is selected from the group consisting of polymer foils, metal foils, paper and/or card and is preferably white, and the at least one indicator dye is selected from the group consisting of 2′,4′,5′,7′-tetraiodofluorescein (erythrosine B), 3,4,5,6-tetrachloro-2′,4′,5′,7′-tetrabromofluorescein, 3,4,5,6-tetrachloro-2′,4′,5′,7′-tetraiodofluorescein (Rose bengal), and salts thereof.

The at least one indicator dye is applied by suitable techniques to at least one of the surfaces of the carrier material. Examples of application techniques include printing, spreading, rolling, pouring, knifecoating, roller coating, dipping and/or spraying, with rolling, knifecoating and printing being preferred. After application has taken place, any solvents present in the indicator dye are removed by customary drying techniques. The carrier material on which the at least one indicator dye is applied may be protected from damage during storage and transport by application of a temporary protective layer—for example, a polypropylene laminating foil. Furthermore, the carrier may, for example, comprise a pressure-sensitive adhesive layer on the side not coated with the at least one indicator dye, allowing the carrier to be affixed, for example, on a substrate or object or on a carrier for the substrate. The pressure-sensitive adhesive layer may optionally likewise be protected with a laminating foil during storage and transport.

The composition is applied by suitable techniques to a substrate or object and to the carrier material comprising the at least one indicator dye. Substrate and carrier material are located here preferably in direct spatial vicinity, and so the curing of the further constituents of the composition on the substrate, and the curing of the composition on the carrier material, take place under conditions that are as far as possible the same. For example, the carrier material may be fixed on the edge of the substrate or on a mount which holds the substrate during coating.

Techniques for applying the composition to substrate or object and to the carrier material comprising the at least one indicator dye are, for example, printing, spreading, roller coating, pouring, knifecoating, rolling, dipping, fluidized bed processes and/or, preferably, spraying, such as compressed air spraying, airless spraying, and high-speed rotary atomization, for example. Spray application may optionally be combined with electrostatic charging of the atomized particles (ESTA), and/or may optionally be combined with hot spray application, such as hot-air hot spraying or hot steam spraying, for example. For spraying techniques which utilize a gas for atomization and/or for transferring the atomized particles, suitable gases include not only air but also others such as nitrogen, carbon dioxide or steam, for example.

Suitable substrates or objects are, for example, substrates comprising one or more materials, including, in particular, those referred to as composite materials. A substrate formed from at least two materials is referred to in accordance with the invention as composite material. Suitable materials are, for example, wood, metal, plastic, paper, leather, textiles, felt, glass, woodbase materials, cork, rubber, linoleum, inorganically bound substrates such as wood and fiber cement boards, electronic assemblies or mineral substrates. Suitable types of composite material are, for example, particle composite materials, also referred to as dispersion materials, fiber composite materials, laminar composite materials, also referred to as laminates, penetration composite materials and structural composite materials.

Suitable metals are, for example, steel, aluminum, magnesium and alloys of metals as used in the applications of so-called wire coating, coil coating, can coating or container coating, and the like.

In the context of the invention, the term plastic also comprehends fiber-reinforced plastics, for example glass fiber- or carbon fiber-reinforced plastics, and plastics blends composed of at least two or more plastics. Examples of plastics suitable in accordance with the invention are ABS, AMMA, ASA, CA, CAB, EP, UF, CF, MF, MPF, PF, PAN, PA, PE, HDPE, LDPE, LLDPE, UHMWPE, PET, PMMA, PP, PS, SB, PUR, PVC, RF, SAN, PBT, PPE, POM, PUR-RIM, SMC, BMC, PP-EPDM and UP (abbreviations according to DIN 7728T1). These may also be in the form of films or in the form of glass fiber- or carbon fiber-reinforced plastics.

The substrates may have already been coated wholly or partly with one or more coating films. These coating films may still be uncured or damp, partly cured or fully cured; the further coating films on the substrate are preferably partly cured or fully cured. Examples of coating films are priming coats, primers, surfacers, filling coats, basecoats, or substrates which have already been fully painted and which are being recoated after possible pretreatment such as sanding or plasma activation. Especially suitable are substrates of the kind which occur in refinishing or finishing in the context of renovations or maintenance on vehicles, especially in the case of ships, aircraft, motor vehicles such as automobiles, trucks, coaches, large vehicles, rail vehicles.

The application of the composition of the indicator system of the invention is followed by the curing and/or the drying of this composition on the substrate or object and optionally on the carrier material. This takes place according to techniques which are customary in coating technology, either under ambient conditions in respect of temperature and atmospheric humidity, or under forced conditions, through—for example—temperature increase in ovens, use of radiation such as infrared or near-infrared or microwave radiation, for example, and use of dehumidified and/or heated air or other gases. It is preferred here to do without the use of apparatus for forced curing, or to use only an apparatus which allows the decoloring of the at least one indicator dye to be monitored with the human eye. During the curing of the composition, there is a gradual fading of the color of the at least one indicator dye, preferably to the point of colorlessness for the human eye, which therefore indicates that curing has taken place.

A further subject of the invention is a method for optically indicating the curing progress of a composition which comprises at least one NCO-reactive compound and at least one polyisocyanate, characterized in that the method comprises the following steps:
(a) providing at least one indicator dye, the at least one indicator dye having at least one xanthene skeleton,
(b) contacting the at least one indicator dye from step (a) with the uncured composition, the at least one indicator dye having a first color, and
(c) curing the composition, the at least one indicator dye indicating the curing of the composition through color switch from the first color to colorless.

The indicator system of the invention constitutes the composition used in the method of the invention and comprising at least one NCO-reactive compound and at least one polyisocyanate, and also the at least one indicator dye. The statements made above concerning further embodiments and preparation pathways and possible processing steps are valid analogously for the method of the invention.

The contacting of the at least one indicator dye with the uncured composition may be accomplished, as described above, by mixing with the composition or by prior application of the at least one indicator dye to a carrier material, subsequent detachment from the carrier material, and mixing of the at least one indicator dye with the composition applied on the carrier.

In one preferred embodiment, the composition is applied to a substrate or object or the latter has been coated with the composition. With regard to the substrate or object, the statements made above concerning the nature of the substrate and the further embodiments are likewise valid.

In one preferred embodiment, the at least one indicator dye from step (a) is applied on the surface of an inert carrier. Preferably, the inert carrier is a polymer foil or a glass fiber web, more preferably a polymer foil, more particularly a polyethylene terephthalate or polycarbonate foil. In a further preferred embodiment, the inert carrier is applied by a second surface, which faces away from the first surface, on a second inert carrier. The second carrier is preferably selected from the group consisting of polymer foils, metal foils, paper and/or card. In one preferred embodiment, the first carrier is colorless and transparent, and the second carrier is white. For the first and second carrier, the statements made above concerning the nature of the carriers and the further embodiments are likewise valid.

A further subject of the present invention is a method for optically ascertaining the curing progress of a composition comprising at least one NCO-reactive compound and at least one polyisocyanate, with at least one indicator dye, the at least one indicator dye having at least one xanthene skeleton, characterized in that, after contacting of the at least one indicator dye with the composition, the color of the at least one indicator dye is compared with a color scale in order to ascertain the curing progress.

The indicator system of the invention constitutes the composition used in the method of the invention and comprising at least one NCO-reactive compound and at least one polyisocyanate, and also the at least one indicator dye. The statements made above concerning further embodiments and preparation pathways and possible processing steps are valid analogously for the method of the invention.

The contacting of the at least one indicator dye with the uncured composition may be accomplished, as described above, by mixing with the composition or by prior application of the at least one indicator dye to a carrier material, subsequent detachment from the carrier material, and mixing of the at least one indicator dye with the composition applied on the carrier.

This makes it possible first to examine a given composition and its curing with an indicator dye and to establish a correlation between the degree of cure and the intensity of coloration of the dye for a given concentration and film thickness. For the degree of curing it is possible, for example, to employ the determination of the degree of drying in accordance with DIN EN ISO 9117-5:2012. An additional possibility is to use drying time instruments or drying recorders such as the model from Byk-Gardner GmbH, Geretsried, DE, or the model 450 from Erichsen GmbH & Co. KG, Hemer, DE, which can operate in accordance with standards ASTM D 5895 (Jun. 1, 2013), ISO 9117-4:2012 and/or DIN EN 14022:2010. Simple trial and error can also be used to determine the earliest possible time for further processing such as, for example, sanding, polishing, packing, mounting, laminating, printing, lasering, joining, coating, washing, cleaning, diecutting, stitching, winding, stacking, deforming, testing, subjecting to electrical current, bringing out of a protected environment, or recoating. When the degree of decoloring has been determined by such preliminary tests, for a given composition and for the desired curing, the degree of curing necessary for further processing can be simply read off from the decoloring of the indicator system, on a repetition or on multiple coating of substrates, and accordingly the further processing can take place at the earliest technically rational time, without any need for further measurements or for the surface of the composition to be contacted. In one preferred embodiment, for comparing the desired decoloring, a corresponding reference surface is provided—for example, a white paper surface printed with a hue, or an area displayed in colored form on an electronic screen—on which the desired decoloring of the indicator system is specified in colored form and invariably. This can be done either through provision only of the single desired comparison hue, or by provision of a color scale, allowing the complete processing of decoloring to be monitored up to the desired degree of decoloring. In that case it is possible for the human eye to determine the earliest technically rational time for further processing, by a color comparison between the invariant color of the reference surface and the fading color of the indicator dye. Where a color scale is used, unambiguous marking of the corresponding hue, by means of letters or digits, for example, can be used to stipulate which hue the color of the indicator dye must fade to before the coated substrate is to be further-processed. The provision of the comparison hue or of the color scale may be accomplished in this case by customary printing techniques or by representation of customary screens suitable for color display.

A further subject of the present invention is a kit of parts comprising at least one indicator dye, the at least one indicator dye having at least one xanthene skeleton, a composition comprising at least one NCO-reactive compound and at least one polyisocyanate, the at least one indicator dye preferably being applied on a first surface of an inert carrier, the inert carrier preferably being applied by a second surface, which faces away from the first surface, on a second inert carrier, the second carrier preferably being white.

The indicator system of the invention constitutes the composition used in the kit of parts of the invention and comprising at least one NCO-reactive compound and at least one polyisocyanate, and also the at least one indicator dye and the one inert carrier. The statements made above concerning further embodiments and preparation pathways and possible processing steps are valid analogously for the kit of parts of the invention.

In one preferred embodiment, the above-described at least one indicator dye applied to a carrier material, including optional protective and/or adhesive layer or layers, may be used together with a color scale and, optionally, instructions for use as a kit of parts, together or separately to the composition. Preferably in this case the information regarding the color of the at least one indicator that corresponds to the earliest technically rational time for further processing is enclosed with the kit of parts or the composition. For example, a kit of parts comprising a color scale and a plurality of white foils coated with at least one indicator dye can be included with a 2K PU clearcoat system for automotive refinish. Before the clearcoat is applied, the coater then mounts a foil, coated with at least one indicator dye, on the carrier which holds the part to be coated, the mounting being such that upon coating the customary paint-gun cross-pass causes approximately the same amount of coating material that is applied to the substrate to land also on the foil bearing the at least one indicator dye. Upon fading of the color on the foil, with the aid of the color scale included in the kit of parts, as a reference, and with the aid of the target coloration ascertained and transmitted beforehand, by the coating material supplier, for example, the coater is able to ascertain when the desired degree of cure has been reached, allowing sanding and polishing to be commenced or allowing the vehicle to be parked in the open even under rain.

A further subject of the present invention is a method for increasing the cycle frequency between a coating step and a further downstream step in the procmessing of objects which are coated with a composition which comprises at least one NCO-reactive compound and at least one polyisocyanate, characterized in that at least one indicator dye is contacted with the composition in order to indicate the curing progress of the coating, the at least one indicator dye having at least one xanthene skeleton.

The indicator system of the invention constitutes the composition used in the method of the invention and comprising at least one NCO-reactive compound and at least one polyisocyanate, and also the at least one indicator dye. The statements made above concerning further embodiments and preparation pathways and possible processing steps are valid analogously for the method of the invention.

The contacting of the at least one indicator dye with the uncured composition may be accomplished, as described above, by mixing with the composition or by prior application of the at least one indicator dye to a carrier material, subsequent detachment from the carrier material, and mixing of the at least one indicator dye with the composition applied on the carrier.

Because the indicator system of the invention indicates the earliest technically rational time for further processing, by comparison with a color reference, it can be used to increase the cycle frequency in operations which require, for example, contactless determination of the degree of cure of a coating and in which contactless but apparatus-based determination of the degree of cure of a coating is undesirable or uneconomic. In place of an apparatus, use is made of the capacity of the human eye to allow hues to be compared with sufficient accuracy. A process comprising at least one coating step, at least one step of curing the coating or composition applied to at least one substrate in the coating step, and at least one step wherein the coated substrate is further-processed and for which the coating must be cured to a defined degree, can be accelerated in its cycle time through use of the indicator system. To those skilled in the art it is clear that the degree of curing of the coating or composition is dependent on the subsequent method step and/or the further processing. Examples of the subsequent method step or further processing are sanding, polishing, packing, mounting, laminating, printing, lasering, joining, coating, washing, cleaning, diecutting, stitching, winding, stacking, deforming, testing, subjecting to electrical current, bringing out of a protected environment, or recoating.

A further subject of the present invention is the use of an indicator dye with xanthene skeleton, preferably with fluoran skeleton, for optically indicating the curing progress of compositions comprising at least one NCO-reactive compound and at least one polyisocyanate, characterized in that the indicator dye has a first color after contacting with the uncured composition and in the sufficiently cured composition is colorless.

The indicator system of the invention constitutes the inventively used indicator dye and the composition used that comprises at least one NCO-reactive compound and at least one polyisocyanate. The statements made above concerning further embodiments and preparation pathways and possible processing steps are valid analogously for the method of the invention.

The contacting of the indicator dye with the uncured composition may be accomplished, as described above, by mixing with the composition or by prior application of the indicator dye to a carrier material, subsequent detachment from the carrier material, and mixing of the indicator dye with the composition applied on the carrier.

In one preferred embodiment, the composition is a polyurethane coating material, in a particularly preferred embodiment a polyurethane clearcoat.

Furthermore, the intention is to illustrate the present invention by means of the examples which follow.

### EXAMPLE

### 1) General Remarks

1.1) Determination of drying level in accordance with DIN EN ISO 9117-5:2012: Using a four-way paint applicator, the coating material under test was drawn down on a glass plate. The measurement of time began with the act of drawdown.

Drying level 1 (T1) was awarded when, using a fine-hairbrush, it was possible to remove around 0.5 g of fine glass beads (diameter 2 mm) scattered over the surface.

For drying levels 2 to 4 (T2 to T4), the coating on a filter paper was loaded with different weights (T2 20 g, T3 200 g, T4 2 kg) for a duration of 60 seconds, after which the sample plate was dropped onto the bench top vertically from a height of about 30 mm. If the paper fell off, the drying level was reached.

Drying level 5 (T5) was tested as for drying level 4. For this level, however, there had to be no perceptible change in the surface of the loaded coating.

1.2) Color values according to color scale: A color scale was drawn up, and then compared with the appearance of the coatings. The color scale was drawn up using the RGB color space provisions of the Microsoft® Excel® 2010 software (Format Cells/FillMore Colors/Custom), with each hue being assigned a number in sequence of falling color intensity (from 1—really intensive magenta red to 14—colorless) and being printed out using a commercial printer (RICOH MP C 3003) on white paper (name IQ appeal 80 g/m² from Mondi Paper Sales Deutschland GmbH, Unterföhring, DE).

For the visual assessment, clearcoats were drawn down onto a colorless glass plate in a wet film thickness of 200 m using a film-drawing frame (Byk-Gardner GmbH, Geretsried, DE). The coated glass plate was then placed onto a white paper sheet (manufacturer as above) and the hue was compared visually with the color scale during and/or after drying/curing.

TABLE 1
Color scale based on RGB color model

| Defined | | | |
|---|---|---|---|
| color value | Red | Green | Blue |
| 1 | 230 | 0 | 126 |
| 2 | 255 | 21 | 149 |
| 3 | 255 | 41 | 158 |
| 4 | 255 | 63 | 168 |
| 5 | 255 | 83 | 177 |
| 6 | 255 | 101 | 185 |
| 7 | 255 | 121 | 194 |
| 8 | 255 | 143 | 204 |
| 9 | 255 | 163 | 213 |
| 10 | 255 | 183 | 222 |
| 11 | 255 | 201 | 231 |
| 12 | 255 | 221 | 240 |
| 13 | 255 | 243 | 250 |
| 14 | 255 | 255 | 255 |

### 1.3) Chemicals Used

The following dyes were obtained from Sigma-Aldrich Chemie GmbH, Munich, DE, and used without further pretreatment:

Dye #1 (I=inventive): 2′,4′,5′,7-Tetrabromo-3,4,5,6-tetrachlorofluorescein
Dye #2 (1): 2′,4′,5′,7′-Tetrabromofluorescein disodium salt (eosin Y)
Dye #3 (1): 2′,4′,5′,7′-Tetraiodofluorescein (erythrosine B)
Dye #4 (1): 3,4,5,6-Tetrachloro-2′,4′,5′,7′-tetraiodofluorescein (rose bengal)
Dye #5 (I): 2′,4′,5′,7′-Tetrabromo-3,4,5,6-tetrachlorofluorescein disodium salt (phloxine B)
Dye #6 (C=comparative example): 2,6-Diphenyl-4-(2,4,6-triphenyl-1-pyridinio)phenolate (Reichardt dye)
Dye #7 (C): 5-Amino-9-(diethylamino)benzo[a]phenoxazin-7-ium (Nile blue)
Dye #8 (C): 3,3-Bis(4-dimethylaminophenyl)-6-dimethylaminophthalide (crystal violet lactone)
Dye #9 (C): 3,7-Diamino-5-phenylphenazinium chloride (phenosafranine)
DBTL: Dibutyltin dilaurate, catalyst, CAS 77-58-7 (Aldrich, DE),
Setalux® D A HS 1272 (72% in butyl acetate): OH-containing polyacrylate polyol (Nuplex, NL),
MPA: I-Methoxy-2-propyl acetate, CAS 108-65-6, solvent (BASF SE, DE),
Butyl acetate: Acetic acid n-butyl ester, CAS 123-86-4, solvent (BASF SE, DE),
Xylene, solvent (Azelis, BE)
Desmodur® N 3600, polyisocyanate based on trimers of hexamethylene diisocyanate, NCO content 23.0%, viscosity 1200 mPa s at 23° C. (Covestro Deutschland AG, DE)
Permasolid® HS Optimum plus KL 8650, VOC-compliant high-solids automotive refinish clearcoat (SPIES HECKER GMBH, DE)
Permacron® 3380 diluent, solvent mixture for diluting Permasolid HS Optimum plus KL 8650 (SPIES HECKER GMBH, DE)
Permasolid® VHS curing agent 3225, curing agent for automotive refinish clearcoats based on aliphatic polyisocyanates (SPIES HECKER GMBH, DE)
Byk 349: Silicone surfactant for aqueous paints, adhesives and polishes, with sharp reduction in surface tension and consequently good substrate wetting (Byk Chemie GmbH, DE),
Byk 378: Solvent-free silicone surface additive for aqueous, solventborne and solvent-free systems, for increasing surface smoothness and for sharply reducing surface tension (Byk Chemie GmbH, DE)
Bayhydrol® A 2695: OH-containing polyacrylate-polyol dispersion in water and propylene glycol n-butyl ether (Covestro Deutschland AG, DE)
Bayhydrol® U XP 2750: OH-containing aqueous polyester-polyurethane dispersion (Covestro Deutschland AG, DE)
3M Noveca FC-4430, fluorosurfactant (3M Deutschland GmbH, DE)
Borchi® Gel PW 25, liquid, polyurethane-based thickener (OMG Borchers GmbH, DE)
Desmophen® XP 2488, polyester polyol, hydroxyl content 16.0%, viscosity 12 250 mPas at 23° C. (Covestro Deutschland AG, DE)
Desmodur® N 3900, polyisocyanate based on trimers of hexamethylene diisocyanate, NCO content 23.5%, viscosity 730 mPa s at 23° C. (Covestro Deutschland AG, DE)
Bentone® 38, organic derivative of a hectorite mineral for rheology control (Elementis Service Centre NV, NL)
Makrofol® DE 1-1 000000, polycarbonate foil (Covestro Deutschland AG, DE)
Adhesive laminating foil GH-X173 natural (from Bischof u. Klein, Germany)

### 2) Examples

### 2.1) Example 1: Preparation of a Clearcoat Formulation with Dye Indicators, and Application and Drying Thereof

TABLE 2
Preparation of indicator dye solutions

| | | Amount of | Diacetone | Color |
|---|---|---|---|---|
| Indicator | Indicator | indicator | alcohol | of |
| solution | dye | dye [mg] | [g] | solution |
| 1 (I) | #1 | 46 | 10 | Red |
| 2 (I) | #2 | 54 | 10 | Orange |
| 3 (I) | #3 | 83 | 10 | Red |
| 4 (I) | #4 | 42 | 10 | Red |
| 5 (I) | #5 | 53 | 10 | Red |
| 6 (C) | #6 | 47 | 10 | Blue |
| 7 (C) | #7 | 42 | 10 | Blue |
| 8 (C) | #8 | 68 | 10 | Colorless |
| 9 (C) | #9 | 54 | 10 | Red |

Key: I = Inventive, C = Comparative example

The indicator dyes prepared were first mixed with an isocyanate-reactive coating component by stirring. The perceived color of the solution was recorded after the end of the stirring procedure (table 4). Then an isocyanate-containing component was added and stirred in homogeneously, and the perceived color was recorded (table 4), and the coating material (see table 3) together with indicator dye was drawn down onto a colorless glass plate at 200 m (wet) using a film-drawing bar, and the perceived color of the wet drawdown was recorded (table 4). The coating was dried at room temperature for 16 hours and changes in the color were monitored optically, until the coating was dry and hard. For comparison, in each case only the isocyanate-reactive component with indicator, but without isocyanate-containing component, was drawn down and dried. These drawdowns were still tacky after 16 hours. Furthermore, both the clearcoat with indicator and just the isocyanate-reactive component with indicator were each kept in a closed glass bottle, and the change in color was assessed visually after 16 hours. The isocyanate-reactive component kept in the bottle was still liquid. The clearcoat in the bottle reacted to form a viscous mass. The observed colors of the liquid and drawn-down coatings are set out in table 4.

TABLE 3
Composition of coating 1- solventbome 2K PU clearcoat

| | Initial |
|---|---|
| Coating 1 | mass |
| Isocyanate-reactive component | |
| Setalux ® DAHS 1272 | 50.0 g |
| Dibutyltin dilaurate | 1.6 g |
| (1% solution in n-butyl acetate) | |
| Mixture of Butyl acetate/1-methoxyprop-2-yl | 14.0 g |
| acetate/xylene (1/1/1) | |
| Indicator dye | 2.0 g |
| Isocyanate-containing component | |
| Desmodur ® N 3600 | 18.4 g |
| Mixture of Butyl acetate/1-methoxyprop-2-yl | 14.0 g |
| acetate/xylene (1/1/1) | |
| Total (coating) | 100.0 g |

TABLE 4
Observed colors of indicator dye solutions, of mixtures of the indicator dye solutions with
the NCO-reactive component and also with the composition in glass bottles and the coating
drawdowns - both immediately after mixing and after 16 h storage at room temperature.

| | Example | | | | | | | | |
|---|---|---|---|---|---|---|---|---|---|
| | 1-1 | 1-2 | 1-3 | 1-4 | 1-5 | 1-6 | 1-7 | 1-8 | 1-9 |
| | (I) | (I) | (I) | (I) | (I) | (C) | (V) | (C) | (C) |
| Indicator dye | #1 | #2 | #3 | #4 | #5 | #6 | #7 | #8 | #9 |
| Color of indicator dye | Red | Red | Red | Red | Red | Blue | Blue | Colorless | Red |
| solution | | | | | | | | | |
| Color of isocyanate- | Red | Red | Red | Red | Red | Brown | Violet | Colorless | Red |
| reactive component | | | | | | | | | |
| with indicator dye | | | | | | | | | |
| solution | | | | | | | | | |
| immediately in the | | | | | | | | | |
| bottle | | | | | | | | | |
| Color of isocyanate- | Red | Red | Red | Red | Red | Brown | Violet | Colorless | Red |
| reactive component | | | | | | | | | |
| with indicator dye | | | | | | | | | |
| solution in the bottle | | | | | | | | | |
| after 16 h | | | | | | | | | |
| Color of coating 1 with | Red | Red | Red | Red | Red | Brown | Violet | Colorless | Red |
| indicator dye solution | | | | | | | | | |
| immediately in the | | | | | | | | | |
| bottle | | | | | | | | | |
| Color of coating 1 in | Red | Red | Red | Red | Red | Brown | Violet | Colorless | Red |
| the bottle with indicator | | | | | | | | | |
| dye solution | | | | | | | | | |
| in the bottle after 16 h | | | | | | | | | |
| Glass drawdown, | Red | Red | Red | Red | Red | Green | Violet | Colorless | Red |
| coating 1 | | | | | | | | | |
| immediately | | | | | | | | | |
| Glass drawdown, | Colorless | Colorless | Colorless | Colorless | Colorless | Green | Violet | Colorless | Red |
| coating 1 | | | | | | | | | |
| after 16 h | | | | | | | | | |

Examples 1-1 to 1-9 above show that all of the coatings when kept in the bottle react to form a viscous mass, owing to the inability of the solvents used to escape. In these cases there is no change in color.

Examples 1-1 to 1-5 according to the invention show that the coatings change color on drying and curing on a glass plate. The color intensities decrease over 16 hours. Coatings comprising the indicator dye #1, #2, #3, #4 and #5 are colorless after 16 h. The clearcoats containing the comparative dyes (solvatochrom #6; redox or pH indicators #7, #8, #9), on the other hand, do not change color during drying and curing of the coating.

### 2.2) Example 2

The coatings from example 1, with indicators #1, #3 and #4 added, were again drawn down onto glass plates and dried at room temperature. On full decoloring of the coating (color value 14 according to color scale), the drying level of the coating was immediately determined.

TABLE 5
Detertnination of the drying level of coatings with three different indicators

| Example 2-1 with coating 1 | | Example 2-2 with coating 1 | | Example 2-3 with coating 1 | |
|---|---|---|---|---|---|
| and | | and | | and | |
| indicator | Drying | indicator | Drying | indicator | Drying |
| dye | level | dye | level | dye | level |
| #1 | T3 | #2 | T1 | #3 | T1 |

Example 2 shows that different drying levels of the coatings can be indicated depending on the indicator dye of the invention that is selected.

### 2.3) Example 3

A commercial 2K PU high-solids automotive refinish clearcoat was prepared according to the manufacturer's instructions (A datasheet No. DE/8650/05 Permasolid® HS Optimum Plus Clearcoat 8650, Spiess Hecker GmbH, DE of Aug. 28, 2012), with the modification that the indicator #1 was stirred into the isocyanate-reactive component before it was mixed with the isocyanate-reactive and isocyanate-containing (curing) component (table 6).

TABLE 6
Composition of coating 2 - commercial 2K PU automotive refinish
clearcoat with indicator

| | [g] |
|---|---|
| Isocyanate-reactive component | |
| Permasolid HS Optimum plus KL 8650 | 100.0 |
| Permacron diluent 3380 | 11.3 |
| Indicator #1 (I) | 1.0 |
| Isocyanate-containing component | |
| Permasolid VHS curing agent 3225 | 36.1 |

The clearcoat with indicator was subsequently drawn down as described in example 1 onto a glass plate and dried at room temperature. In the course of drying, the color of the coating was compared with the color scale at defined times (table 7).

TABLE 7
Change in color values over time, according to color scale, of coating
2 drawn down onto a glass plate, during drying and curing

| Time | Defined color values according to color scale |
|---|---|
| 0 min [start] | 6 (red) |
| 20 min | 7 |
| 150 min | 11 |
| 240 min | 13 |
| 300 min | 14 (fully decolored) |

According to indications by the manufacturer in the datasheet, the coating attains the following drying levels at +20° C. room temperature: dust-dry 15-30 minutes, assembly-ready 2-5 hours, dry overnight. The example shows that a particular drying level such as readiness for assembly can be easily ascertained visually using the color scale and the indicator dyes of the invention.

### 2.4) Example 4

The following coatings (tables 8 and 10) were prepared in the same way as for example 1, and applied to glass plates and dried at room temperature. During drying, the color of the coating was compared with the color scale at defined times (tables 9 and 11).

TABLE 8
Composition of coatings 5-1 and 5-2 - aqueous 2K polyurethane coatings
with indicator dye, based on a polyacrylate polyol (5-1) and
on a polyester-polyurethane polyol (5-2)

| Input weights in [g] | Coating 5-1 | Coating 5-2 |
|---|---|---|
| Isocyanate-reactive component | | |
| Bayhydrol ® A 2695 | 41.5 | |
| Bayhydrol ® UXP 2750 | | 50.0 |
| Byk ® 349 | 0.1 | 0.1 |
| Byk ® 378, 10% in water | 0.3 | 0.3 |
| 3M Novec ® FC-4430 | 0.3 | 0.3 |
| Borchi ® Gel PW 25 | 0.3 | 0.3 |
| Water | 13.5 | 10.8 |
| Indicator dye #1 (I) | 1.0 | 1.1 |
| Isocyanate-containing component | | |
| Desmodur N 3600 (60% in Proglyde DMM) | 22.0 | 19.2 |

TABLE 9
Change in color values over time, according to color scale, of coatings 5-1
and 5-2 drawn down onto glass plates, during drying and curing

| | Defined color values according to color scale | |
|---|---|---|
| Time | Coating 5-1 | Coating 5-2 |
| 0 min [start] | 6 | 6 |
| 10 min | 7 | 7 |
| 20 min | 9 | 8 |
| 30 min | 11 | 10 |
| 45 mm | 13 | 12 |
| 50 min | 14 | 12 |
| 75 min | | 13 |
| 80 min | | 14 |

TABLE 10
Composition of coating 5-3, 5-4 and 5-5 - solventborne 2K
PU coatings based on a polyester polyol

| Input weights in [g] | Coating 5-3 | Coating 5-4 | Coating 5-5 |
|---|---|---|---|
| Isocyanate reactive component | | | |
| Desmophen ® XP 2488 | 13.1 | 13.1 | 13.1 |
| Dibutyltin dilaurate (1% solution | 0.7 | 0.7 | 0.7 |
| in n-butyl acetate) | | | |
| Butyl acetate/1-methoxyprop-2-yl | 11.7 | 11.7 | 11.7 |
| acetate (2:1) | | | |
| Indicator dye No. and input weight | #3: 0.5 | #4: 1.0 | #1: 1.0 |
| Isocyanate-containing component | | | |
| Desmodur ® N 3900 | 22.1 | 22.1 | 22.1 |

TABLE 11
Change in color values over time, according to color scale,
of coatings 5-3, 5-4 and 5-5 drawn down onto glass
plates, during drying and curing

| | Defined color values according to color scale | | |
|---|---|---|---|
| Time | Coating 5-3 | Coating 5-4 | Coating 5-5 |
| 0 min [start] | 6 | 10 | 10 |
| 40 min | 11 | 13 | 13 |
| 145 min | 13 | 14 | 14 |
| 280 min | 13 | 14 | 14 |
| 545 min | 13 | | 14 |

The examples above show that the coating constituents can be varied. Not only polyacrylate polyols but also polyester polyols and polyurethane polyols are suitable. Besides coatings which comprise organic solvents, water-based coatings are also suitable according to the invention.

### 2.5) Example 5

Coatings 5-1, 5-2 and 5-3 were each again drawn down onto glass plates and immediately thereafter were dried and cured not at room temperature but instead in a forced-air laboratory oven on racks at 80° C. for 20 minutes. On withdrawal from the oven, all three glass plates were colorless.

This example shows that when drying and curing are carried out at elevated temperature, there is likewise a corresponding change in color that indicates curing.

### 2.6) Example 6

An indicator dye solution was prepared by dissolving 55 mg of indicator dye #5 in 3.63 g of diacetone alcohol and 3.63 g of 1-methoxypropy-2-yl acetate. This solution was admixed with 2.00 g of Bentone® 38, which was stirred in. This suspension was drawn down uniformly using a 0.5 wire-wound coating bar onto a smooth polycarbonate foil of MAKROFOL® DE 1-1 000000 (1 mm thick). The foil was then dried in a forced air oven at 95° C. for 5 minutes. The resulting coated foil was uncolored, with a matt surface. On the side coated with dye, the foil was subsequently lined with an adhesive laminating foil GH-X173 natural (from Bischof u. Klein, Lengerich, Germany). The foil assembly was cut using scissors into strips with a length of 15 cm and a width of 15 cm.

Following removal of the laminating foils, the coating 1 from example 1, albeit without addition of an indicator, was drawn down on a foil strip. Over the course of 10 to 30 seconds, the coating turned red. This was followed by drying at room temperature. In the course of drying, the color of the coating was checked at defined times against the color scale as per table 1 (table 12).

TABLE 12
Change in color values according to the color scale, over time, of coating 1
without indicator dye, drawn down onto polycarbonate foil precoated
with indicator dye, during drying and curing

| | Defined color values according |
|---|---|
| Time | to color scale |
| 0.0 min [start] | 14 (colorless) |
| 0.5 min | 5 (red) |
| 30 min | 6 |
| 60 min | 10 |
| 90 min | 12 |
| 180 min | 13 |
| 210 min | 13 |
| 240 min | 14 (colorless) |

The example above shows that it is also possible to apply the indicator dye to a carrier, where the carrier is subsequently coated with a clearcoat, the latter first takes on color and then decolors again during drying and curing.

### 2.7) Example 7

An operation was carried out in three variants, involving the clearcoat coating of single-part model objects made of plastic from ColorFrog Sri, Druento, IT, these objects being stackable, representing automobile silhouettes, and being already coated with a dried black basecoat material; after coating with the clearcoat, these objects were dried, stacked and packed. In the first variant, the clearcoat was dried for 180 minutes, in the second variant it was dried for 240 minutes, followed in each case by stacking and packing. In the third variant, a polycarbonate film strip (length 5 cm, width 3 cm, like example 5) was coated with indicator dye and attached using a little adhesive tape to the lower edge of the model in each case so that during coating, the major part of the strip was also coated. In this variant drying took place until the color indicator strip was colorless. After two days in the packaging, the stacks were removed and the surfaces were investigated for damage. In the case of variant 1, there was slight damage to the coating surface; in the case of variants 2 and 3, the surfaces were undamaged.

TABLE 13
Multistep processing operations for the coating of stackable
plastics parts with a clearcoat

| | Variants 1 | Variant |
|---|---|---|
| | and 2 [C] | 3 [I] |
| | Time | Time |
| Step | [min] | [min] |
| Remove from store 5 models, coated with | 10 | 10 |
| dried black basecoat, wipe down with | | |
| a cloth and fasten by the underside to | | |
| a wooden rod, using adhesive tape | | |
| Fasten indicator strip centrally to | none | 1 |
| underside of a model using adhesive | | |
| tape, remove lamination | | |
| Place in coating booth, fasten wooden | 2 | 2 |
| rod in holder | | |
| Coat with clearcoat like example 3 | 2 | 2 |
| (without addition of indicator | | |
| dye) by hand, using compressed-air | | |
| spray gun, according to the coating | | |
| manufacturer protocol | | |
| Remove the coated models (touching only | 1 | 1 |
| the wooden rod) and place on drying grid | | |
| Dry at RT according to time stipulated | Variant | none |
| by coating manufacturer to assembly- | 1: 180 | |
| readiness (2 to 5 hours) | Variant | |
| | 2: 240 | |
| Dry at RT until indicator strip is colorless | none | 215 |
| Remove the wooden rod, adhesive tapes | 2 | 3 |
| and, where included, the indicator strip | | |
| Stack the 5 models and package | 2 | 2 |
| the stack in blister films | | |
| Total duration | Variant | 236 |
| | 1: 199 | |
| | Variant | |
| | 2: 259 | |

The example above shows that a process can be accelerated through use of the indicator.

1.-15. (canceled)

16. An indicator system comprising a composition which comprises at least one NCO-reactive compound and at least one polyisocyanate, and comprising at least one indicator dye, the at least one indicator dye having at least one xanthene skeleton, for indicating the curing of the composition by change in color of the at least one indicator dye, wherein the at least one indicator dye has a first color after contacting with the uncured composition and in the cured composition is colorless.

17. The indicator system as claimed in claim 16, wherein the at least one indicator dye is contained in the curable composition.

18. The indicator system as claimed in claim 16, wherein the at least one indicator dye is applied on a surface of an inert carrier, the inert carrier optionally being applied with a second surface, which faces away from the first surface, on a second inert carrier, the second carrier, and the inert carrier being colorless and transparent.

19. The indicator system as claimed in claim 16, wherein the at least one indicator dye has at least one fluoran skeleton.

20. The indicator system as claimed in claim 16, wherein the at least one polyisocyanate in the composition is an aliphatic and/or cycloaliphatic polyisocyanate.

21. The indicator system as claimed in claim 16, wherein the at least one NCO-reactive compound is selected from the group consisting of polyacrylate polyols and polyester polyols.

22. A method for optically indicating the curing progress of a composition which comprises at least one NCO-reactive compound and at least one polyisocyanate, wherein the method comprises the following steps:
(a) providing at least one indicator dye, the indicator dye having at least one xanthene skeleton,
(b) contacting the at least one indicator dye from step (a) with the uncured composition, the indicator dye having a first color, and
(c) curing the composition, the at least one indicator dye indicating the curing of the composition through color switch from the first color to colorless.

23. The method as claimed in claim 22, wherein the at least one indicator dye from step (a) is applied on a surface of an inert carrier.

24. The method as claimed in claim 23, the inert carrier being a polymer foil or a glass fiber web.

25. The method as claimed in claim 22, wherein the inert carrier, by a second surface, which faces away from the first surface, is applied on a second inert carrier, the second carrier, and the inert carrier being colorless and transparent.

26. A method for optically ascertaining the curing progress of a composition comprising at least one NCO-reactive compound and at least one polyisocyanate, with at least one indicator dye which has a first color after contacting with the uncured composition and in the cured composition is colorless, the indicator dye having at least one xanthene skeleton, wherein, after contacting of the at least one indicator dye with the composition, the color of the at least one indicator dye is compared with a color scale in order to ascertain the curing progress.

27. A method comprising utilizing an indicator dye with xanthene skeleton for optically indicating the curing progress of compositions comprising at least one NCO-reactive compound and at least one polyisocyanate, wherein the at least one indicator dye has a first color after contacting with the uncured composition and in the sufficiently cured composition is colorless.

28. The method as claimed in claim 27, wherein the composition is a polyurethane coating material.

29. A kit of parts comprising at least one indicator dye, the at least one indicator dye having at least one xanthene skeleton, a composition comprising at least one NCO-reactive compound and at least one polyisocyanate, the at least one indicator dye having a first color after contacting with the uncured composition and in the cured composition being colorless.

30. A method for increasing the cycle frequency between a coating step and a further downstream step in the processing of objects which are coated with a composition which comprises at least one NCO-reactive compound and at least one polyisocyanate, wherein at least one indicator dye having a first color after contacting with the uncured composition and in the cured composition being colorless is contacted with the composition in order to indicate the curing progress of the coating, the at least one indicator dye having at least one xanthene skeleton.
